(19) United States
(12) Patent Application Publication
(10) Pub. No.: US 2024/0063936 A1
(43) Pub. Date: Feb. 22, 2024

(54) SYSTEMS AND METHODS FOR UTILIZING PHOTONIC DEGREES OF FREEDOM IN A PHOTONIC PROCESSOR

(71) Applicant: Lightmatter, Inc., Boston, MA (US)

(72) Inventors: Darius Bunandar, Boston, MA (US); Michael Gould, La Honda, CA (US); Nicholas C. Harris, Boston, MA (US); Carl Ramey, Westborough, MA (US)

(73) Assignee: Lightmatter, Inc., Boston, MA (US)

(21) Appl. No.: 18/321,384

(22) Filed: May 22, 2023

Related U.S. Application Data
(63) Continuation of application No. 17/383,509, filed on Jul. 23, 2021, now Pat. No. 11,700,078.
(60) Provisional application No. 63/056,494, filed on Jul. 24, 2020.

(51) Int. Cl. H04J 14/04

(52) U.S. Cl. CPC H04J 14/04; H04B 10/5051

(57) ABSTRACT

Systems and methods for increasing throughput of a photonic processor by using photonic degrees of freedom (DOF) are provided. The photonic processor includes a multiplexer configured to multiplex, using at least one photonic DOF, multiple encoded optical signals into a multiplexed optical signal. The photonic processor also includes a detector coupled to an output of an optical path including the multiplexer, the detector being configured to generate a first current based on the multiplexed optical signal or a demultiplexed portion of the multiplexed optical signal. The photonic processor further includes a modulator coupled to and output of the detector, the modulator being configured to generate a second current by modulating the first current.

### CROSS-REFERENCE TO RELATED APPLICATIONS

This application claims the benefit under 35 U.S.C. § 120 and is a Continuation of U.S. application Ser. No. 17/383,509, filed Jul. 23, 2021 under Attorney Docket No. L0858.70030US01, and titled “Systems and Methods for Utilizing Photonic Degrees of Freedom in a Photonic Processor,” which claims priority under 35 § USC 119(e) to U.S. Provisional Patent Application Ser. No. 63/056,494, filed Jul. 24, 2020, entitled “Systems and Methods for Utilizing Photonic Degrees of Freedom in a Photonic Processor,” under Attorney Docket No. L0858.70030US00, each of which is hereby incorporated herein by reference in its entirety.

### BACKGROUND

Deep learning, machine learning, latent-variable models, neural networks and other matrix-based differentiable programs are used to solve a variety of problems, including natural language processing and object recognition in images. Solving these problems with deep neural networks typically requires long processing times to perform the required computation. The most computationally intensive operations in solving these problems are often mathematical matrix operations, such as matrix multiplication.

### SUMMARY

Some embodiments are directed to a photonic processor. The photonic processor comprises: a multiplexer configured to multiplex, using at least one photonic degree of freedom, multiple encoded optical signals into a multiplexed optical signal; a detector coupled to an output of an optical path including the multiplexer, wherein the detector is configured to generate a first current based on the multiplexed optical signal or a demultiplexed portion of the multiplexed optical signal; and a modulator coupled to an output of the detector and configured to generate a second current by modulating the first current.

In some embodiments, the at least one photonic degree of freedom is one of a selection of wavelength, frequency, or polarization.

In some embodiments, the photonic processor further comprises a demultiplexer configured to demultiplex the multiplexed optical signal.

In some embodiments, the multiplexer is configured to multiplex in an optical domain and the demultiplexer is configured to demultiplex in the optical domain.

In some embodiments, the photonic processor further comprises a demultiplexer configured to demultiplex the second current.

In some embodiments, the multiplexer is configured to multiplex in an optical domain and the demultiplexer is configured to demultiplex in an RF domain.

In some embodiments, the photonic processor is a dual rail photonic processor.

In some embodiments, the photonic processor is single-ended.

Some embodiments are directed to a photonic device configured to perform a mathematical operation. The photonic device comprises: optical encoders; a multiplexer coupled to outputs of the optical encoders, wherein the multiplexer is configured to multiplex, using at least one photonic degree of freedom, encoded optical signals from the optical encoders into a multiplexed optical signal; detectors coupled to outputs of an optical path including the optical encoders and the multiplexer and configured to output first currents; modulators coupled to an output of two detectors of the detectors; and a controller coupled to the optical encoder and the modulators. The controller is configured to: obtain a first numeric values and second numeric values, control the optical encoders to generate the encoded optical signals by modifying input optical signals using the first numeric values, control the modulators to generate second currents based on the first currents, wherein controlling the modulators comprises setting a characteristic of the modulators based on the second numeric values, and obtain a result of the mathematical operation using the second currents.

In some embodiments, the at least one photonic degree of freedom is one of a selection of wavelength, frequency, or polarization.

In some embodiments, the photonic device further comprises a demultiplexer configured to demultiplex the multiplexed optical signal.

In some embodiments, the multiplexer is configured to multiplex in an optical domain and the demultiplexer is configured to demultiplex in the optical domain.

In some embodiments, the photonic device further comprises a demultiplexer configured to demultiplex the second currents.

In some embodiments, the multiplexer is configured to multiplex in an optical domain and the demultiplexer is configured to demultiplex in an RF domain.

In some embodiments, the photonic device is a dual rail photonic device.

In some embodiments, the photonic device is single-ended.

Some embodiments are directed to a method for performing a mathematical operation, the method comprising: obtaining first numeric values and second numeric values; generating encoded optical signals by modifying input optical signals using the first numeric values; multiplexing, using at least one photonic degree of freedom, the encoded optical signals to generate multiplexed optical signals; generating first currents by detecting, using detectors, the multiplexed optical signals or a demultiplexed portion of the multiplexed optical signals; and generating second currents, using modulators and the first currents, by setting a characteristic of the modulators based on the second numeric values; and obtaining a result of the mathematical operation using the second currents.

In some embodiments, multiplexing using at least one photonic degree of freedom comprises multiplexing using at least one of a selection of wavelength, frequency, or polarization.

In some embodiments, the method further comprises demultiplexing the multiplexed optical signals.

In some embodiments, the method further comprises demultiplexing the second currents.

### BRIEF DESCRIPTION OF THE DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a block diagram illustrating a dual-rail optical multiplier, in accordance with some embodiments of the technology described herein.

FIG. 2 is a representation of a matrix-vector multiplication, in accordance with some embodiments of the technology described herein.

FIG. 3 is a block diagram of a photonic processor arranged according to a 2×2 configuration, in accordance with some embodiments.

FIG. 4 is a block diagram of a photonic processor arranged according to a 4×4 configuration, in accordance with some embodiments of the technology described herein.

FIG. 5 is a block diagram of a photonic processor arranged according to a 4×4 configuration and including polarization multiplexing, in accordance with some embodiments of the technology described herein.

FIG. 6A is a block diagram of a photonic processor arranged according to a 4×4 configuration and including wavelength multiplexing, in accordance with some embodiments of the technology described herein.

FIG. 6B is a block diagram of a single-ended photonic processor including wavelength multiplexing, in accordance with some embodiments of the technology described herein.

FIG. 6C is a block diagram of a photonic processor arranged according to a 4×4 configuration and including modulatable detectors and wavelength multiplexing, in accordance with some embodiments of the technology described herein.

FIGS. 7A and 7B are a block diagram of a photonic processor arranged to perform matrix-matrix multiplication of a 4×3 matrix X and a 4×4 matrix M and including frequency multiplexing in the optical domain and frequency demultiplexing in the analog RF domain, in accordance with some embodiments of the technology described herein.

FIG. 8A is a plot showing an example of individual optical frequencies of a multiplexed optical signal, the individual optical frequencies including an optical frequency of a local oscillator (LO), in accordance with some embodiments of the technology described herein.

FIG. 8B is a plot showing the individual optical frequencies of FIG. 8A as encoded in the field amplitude of a multiplexed analog RF signal, in accordance with some embodiments of the technology described herein.

FIG. 9 is a block diagram of an example of circuitry configured to perform dual-rail demultiplexing in the analog RF domain, in accordance with some embodiments of the technology described herein.

FIG. 10 is a block diagram of an example of circuitry configured to perform single-ended demultiplexing in the analog RF domain, in accordance with some embodiments of the technology described herein.

FIG. 11A is a plot showing individual optical frequencies of a multiplexed optical signal, the individual optical frequencies not including the frequency of an LO, in accordance with some embodiments of the technology described herein.

FIG. 11B is a plot showing the individual optical frequencies of FIG. 11A as encoded in the field amplitude of a multiplexed analog RF signal, in accordance with some embodiments of the technology described herein.

FIG. 12 is a flow chart illustrating a method for performing multiplication operations using a photonic processor including multiplexing using one or more photonic degrees of freedom, in accordance with some embodiments of the technology described herein.

### DETAILED DESCRIPTION

### I. Overview

Conventional electronic processors face severe speed, power, and efficiency limitations primarily due to the inherent presence of impedance in electronic interconnects. Connecting multiple processor cores and/or connecting a processor core to a memory involves the use of conductive traces. Large values of impedance limit the maximum rate at which data can be transferred through the conductive traces with a negligible bit error rate. For processing that requires billions of operations, these delays can result in a significant loss of performance. In addition to electrical circuits' inefficiencies in speed, the heat generated by the dissipation of energy caused by the impedance of the circuits is also a barrier in developing electronic processors.

The inventors have recognized and appreciated that using optical signals (instead of, or in combination with, electrical signals) overcomes the aforementioned problems with electronic computing. Optical signals travel at the speed of light in the medium in which the light is traveling. Thus, the latency of optical signals is far less of a limitation than electrical propagation delay. Additionally, no power is dissipated by increasing the distance traveled by the light signals, opening up new topologies and processor layouts that would not be feasible using electrical signals. Thus, photonic processors offer far better speed and efficiency performance than conventional electronic processors.

The inventors have recognized and appreciated that photonic processors are well-suited for particular types of algorithms. For example, many machine learning algorithms (e.g. support vector machines, artificial neural networks and probabilistic graphical model learning) rely heavily on linear transformations on multi-dimensional arrays/tensors. The simplest linear transformation is a matrix-vector multiplication, which using conventional algorithms has a complexity on the order of O(N²), where N is the dimensionality of a square matrix being multiplied by a vector of the same dimension. The inventors have recognized and appreciated that a photonic processor can perform linear transformations, such as matrix multiplication, in a highly parallel manner by propagating a particular set of input optical signals through a configurable array of active optical components. Using such implementations, matrix-vector multiplication of dimension N=512 can be completed in hundreds of picoseconds, as opposed to the tens to hundreds of nanoseconds using conventional electronic circuit-based processing.

General matrix-matrix (GEMM) operations are ubiquitous in software algorithms, including those for graphics processing, artificial intelligence, neural networks and deep learning. GEMM calculations in today's computers are typically performed using transistor-based systems such as GPU systems or systolic array systems. Matrix-vector multiplication using photonics arrays can be highly power efficient when compared to their electronic counterparts as optical signals can propagate within a semiconductor substrate with a minimal amount of loss.

The inventors, however, have recognized and appreciated a number of challenges associated with accelerating the computational speed and increasing the computation density of such photonic arrays. First, the inventors have recognized and appreciated that the throughput of a photonic processor can be increased by multiplexing and demultiplexing input vector signals based on at least one photonic degree of freedom (DOF). A photonic DOF is an independent parameter (e.g., polarization, wavelength, frequency) used to represent a photonic signal. To multiplex input photonic vector signals, for example, the input photonic vector signals may be multiplexed in the optical domain according to wavelength and/or polarization of the input signals. The multiplexed signal may then be demultiplexed in the optical domain using multiple wavelengths and/or polarizations to increase the throughput of the photonic processor. Alternatively, the inventors have developed techniques for performing multiplication operations and subsequent demultiplexing in the analog RF domain.

Second, the inventors have recognized and appreciated that performing multiplexing and demultiplexing both in the optical domain enables an improved density of electronic components in the photonic processor architecture. For example, detectors may be positioned closer to one another in such a photonic processor, thereby reducing the capacitance of the wires connecting the detectors. Such a reduction in capacitance is important because the wire capacitance limits the output bandwidth of the photonic processor.

Third, the inventors have recognized and appreciated that by performing multiplexing in the optical domain and demultiplexing in the analog RF domain, parallel matrix multiplication on multiple input vectors may be performed simultaneously. For a photonic processor using N different wavelengths to encode N different input vectors, N matrix-vector multiplications may be performed simultaneously without the need for any additional photonic modulators or modulatable photodetectors. Accordingly, the techniques described herein can increase the throughput of a photonic processor by a factor of N without increasing the number of photonic and electronic components needed or the amount of power consumed by the photonic processor.

The inventors have accordingly developed novel high-throughput photonic processing architectures for performing matrix-matrix multiplication operations (including matrix-vector multiplication, a core component of GEMM operations). According to an aspect of the present disclosure, the architecture described herein performs multiplexing (e.g., in the optical domain) and demultiplexing (e.g., in the optical domain or the analog RF domain) to perform optical processing in a highly-parallel fashion. In some embodiments, the photonic processor includes optical encoders configured to generate encoded optical signals based on first numeric values (e.g., vector values x) and a multiplexer configured to multiplex, using at least one optical degree of freedom (DOF; e.g., wavelength, frequency, polarization, etc.), the encoded optical signals from the optical encoders into a multiplexed optical signal. The photonic processor also includes detectors coupled to outputs of an optical path including the optical encoders and the multiplexer (e.g., such that the detectors receive the multiplexed optical signal or a demultiplexed portion of the multiplexed optical signal from the optical path). The detectors are configured to convert a received optical signal into a first current (e.g., a photocurrent) received by modulators configured to output second currents based on the received first currents from the detectors and second numeric values (e.g., matrix values M).

The photonic processor may additionally, in some embodiments, include a controller coupled to the optical encoders and the modulators. The controller is configured to obtain the first and second numeric values and to control the optical encoders and the modulators to generate the encoded optical signals and second currents, respectively, based on the first and second numeric values. For example, the controller controls the optical encoders to generate the encoded optical signals by, for example, controlling the optical encoders to modify input optical signals using the first numeric values. The controller also controls the modulators to generate the second currents by setting a characteristic of the modulators based on the second numeric values. Thereafter, the controller may obtain a result of a mathematical operation (e.g., matrix-matrix multiplication, matrix-vector multiplication) using the second currents output by the modulators (e.g., by performing a summation, difference, multiplication or other computation as described herein).

In some embodiments, the photonic processor further includes a demultiplexer configured to demultiplex the multiplexed optical signal. In such embodiments, the multiplexer is configured to multiplex in an optical domain and the demultiplexer is configured to demultiplex in the optical domain. Alternatively, in some embodiments, the photonic processor includes a demultiplexer configured to demultiplex the second current. In such embodiments, the multiplexer is configured to multiplex in an optical domain and the demultiplexer is configured to demultiplex in an analog RF domain.

In some embodiments, the photonic processor is a single-ended photonic processor configured to encode data into a single-ended optical signal. In some embodiments, the photonic processor is a dual-rail photonic processor configured to process optical signals in a differential fashion. In such embodiments, the data is encoded in the difference between a pair of optical signals (e.g., in the difference between the amplitudes or powers of the optical signals).

Following below are more detailed descriptions of various concepts related to, and embodiments of, optical chips and/or packages for realizing high power, single mode optical outputs. It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

### II. Performing Mathematical Operations Using Photonic Circuits

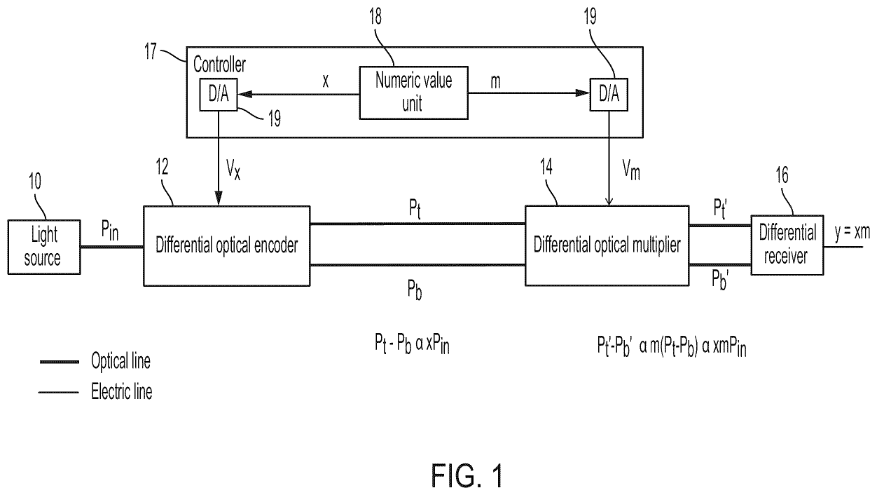

FIG. 1 is a block diagram illustrating an optical multiplier implemented based on a dual-rail architecture, in accordance with some embodiments. This optical multiplier includes a light source 10, a differential optical encoder 12, a differential optical multiplier 14, a differential receiver 16 and a controller 17. Controller 17 includes a pair of digital-to-analog converters (D/A) 19 and a numeric value unit 18.

Numeric value unit 18 produces a pair of scalar numeric values: x and m. Numeric value m is also referred to as “weight” or “weight parameter” and numeric value x is also referred to herein as “input data,” “input value” or “input parameter.” These numeric values may be produced based on data received by the controller, including data obtained from a memory internal to controller 17 and/or data provided to controller 17 from another computing system. These numeric values may be represented using any digital representation, including fixed-point or floating-point representations. The first D/A 19 converts numeric value x to an electric signal representative of x. In this example, the D/A produces a voltage Vₓ. The second D/A 19 converts numeric value m to an electric signal representative of m. In this example, the D/A produces a voltage Vₘ. In some embodiments, Vₓ is proportional to x. In some embodiments, Vₘ is proportional to m. The dual-rail optical multiplier of FIG. 1 is configured to multiply these numeric values to one another, thereby producing the result x×m.

Light source 10 may be implemented using a coherent source, e.g., a laser. Alternatively, light source 10 may be implemented using an incoherent source, e.g., a light-emitting diode, a source of amplified spontaneous emission, or a source of stimulated emission having a relatively large linewidth. As used herein, the terms “coherence” and “coherent” refers to temporal coherence. The optical power produced by light source 10 is identified as “Pᵢₙ.”

Differential optical encoder 12 receives a voltage Vₓ, and in response, produces a pair of optical signals. The labels “Pₜ” and “P_{b}” identify the optical powers of these optical signals, respectively. Differential optical encoder 12 receives voltage Vₓ, and encodes the optical signal received from light source 10 based on Vₓ. More specifically, differential optical encoder 12 produces a pair of optical signals in such a way that the difference between the powers of these optical signals (Pₜ−P_{b}) is proportional to both x and Pᵢₙ (in FIG. 1, the symbol “oc” means “is proportional to”). It should be appreciated that this architecture is referred to as “dual-rail” in that x is encoded in the difference between two optical signals (the difference in the signal powers as in this example, or in other examples, the difference between the signal amplitudes). Differential optical encoder 12 may be implemented using any suitable optical modulator, including an optical interferometer (such as a tunable directional coupler or a Mach-Zehnder interferometer), a resonant modulator, a Franz-Keldysh modulator, etc. Examples of differential optical encoder 12 are described in detail further below.

As discussed above, Pₜ identifies the power of the optical signal at the top rail and P_{b} identifies the power of the optical signal at the bottom rail. In some embodiments, the rails are defined in terms of physical channels. In one example, the top rail is defined in a first optical waveguide and the bottom rail is defined in a second optical waveguide that is physical distinct from the first optical waveguide. In another example, the top rail is defined in a first free-space optical channel and the bottom rail is defined in a second free-space optical channel that is spatially separated from the first free-space optical channel. In other embodiments, however, the top and bottom rails may be defined by a common physical channel. That is, the optical signals generated by differential optical encoder 12 share the same optical waveguide or free-space channel. In these embodiments, the optical signal of each rail is distinguishable from the optical signal of the other rail by a certain optical characteristic, such as by the time bin, polarization or wavelength. In one example, the optical signal at the first rail is defined by a first polarization mode of an optical waveguide (e.g., the optical waveguide's TE₀₀-mode) and the optical signal at the second rail is defined by a second polarization mode of the same optical waveguide (e.g., the optical waveguide's TE₀₁-mode or TM₀₀-mode). In another example, the optical signal at the first rail is defined by a first wavelength and the optical signal at the second rail is defined by a second wavelength.

It should be appreciated that, while FIG. 1 depicts an architecture in which the signals representing the numeric values to be multiplied are voltages (Vₓ and Vₘ), in other embodiments, the numeric values may be represented using other types of electrical signals, such as electric currents or electric charges.

Differential optical multiplier 14 receives the optical signals produced by differential optical encoder 12 and produces a pair of output optical signals based on the voltage Vₘ. The powers of the output optical signals are labeled “Pₜ′” and “P_{b}′” respectively. The optical signals produced by differential optical multiplier 14 are such that the difference between their powers (Pₜ′−P_{b}′) is proportional to both m and the difference Pₜ−P_{b}. The result is that the quantity Pₜ′−P_{b}′ is proportional to each of m, x and Pᵢₙ. Being proportional to both x and m, Pₜ′−P_{b}′, in essence, is encoded with the product of numeric value x times numeric value m.

Differential optical multiplier 14 may be implemented using any suitable photonic device, including any suitable optical interferometer such as an adjustable directional coupler or a Mach-Zehnder interferometer.

Differential receiver 16 detects optical signals Pₜ′ and P_{b}′ and, in response, produces a numeric value y that is equal to the product x×m. To perform this operation, receiver 16 may include for example a pair of balanced photodetectors, a differential trans-impedance amplifier configured to generate an output voltage proportional to Pₜ′−P_{b}′, and an analog-to-digital converter configured to convert the output voltage to a numeric value y.

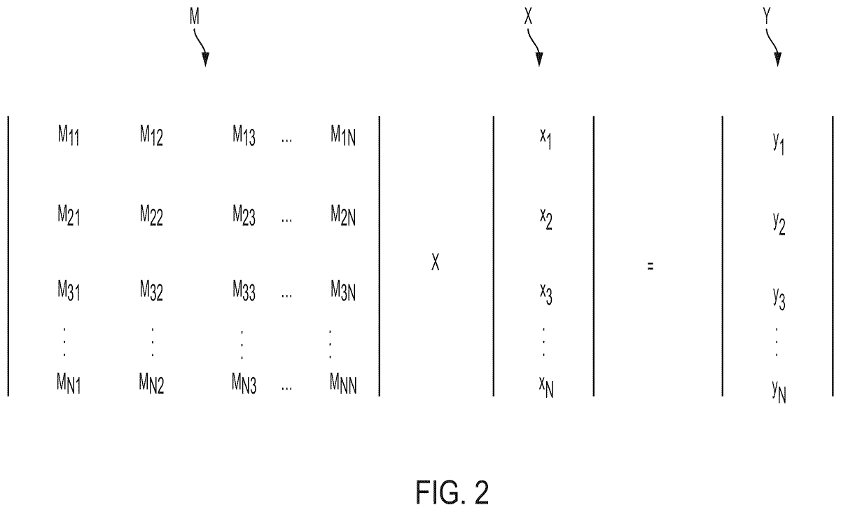

The dual-rail multiplier of FIG. 1 performs scalar multiplications (x times m). However, many machine learning algorithms rely on matrix-matrix (e.g., matrix-vector) multiplication. Some embodiments relate to photonic processors configured to perform matrix-matrix (e.g., matrix-vector) multiplications using the dual-rail optical multipliers described above. These photonic processors are configured to multiply a matrix M by a vector X to produce a vector Y. Matrix M is also referred to herein as “weight matrix,” vector X is also referred to herein as “input vector” and vector Y is also referred to herein as “output vector.” FIG. 2 illustrates an example of such a multiplication. In this example, M is an N×N matrix, though embodiments of the present application are not limited to square matrices or to any specific dimension.

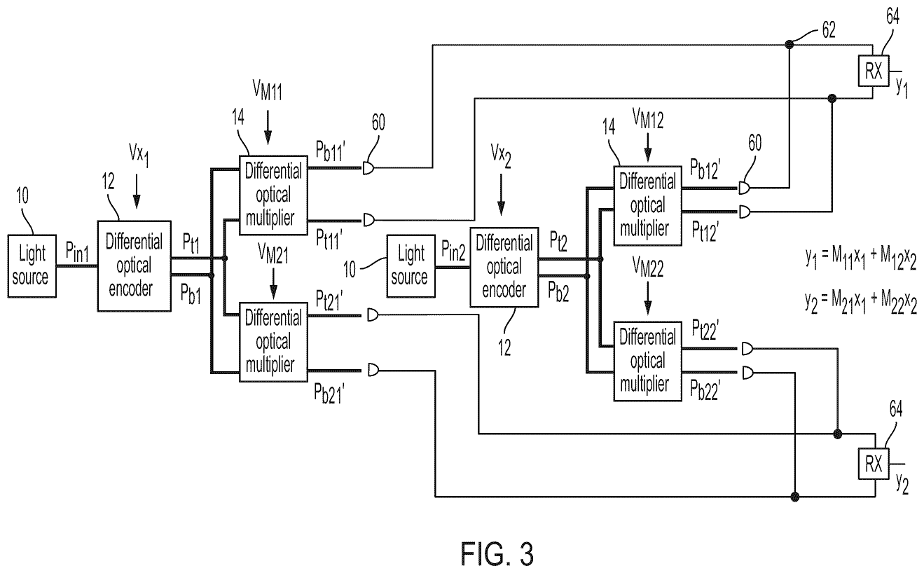

An example of a dual-rail photonic processor is depicted in FIG. 3, in accordance with some embodiments. In this implementation, the photonic processor is configured to multiply a 2×2 matrix (M) by a 2×1 input vector (X) to obtain a 2×1 output vector (Y). A first light source 10 provides an input optical signal having power Pᵢₙ₁ and a second light source 10 provides an input optical signal having power Pᵢₙ₂ (although the same light source may be used in some embodiments). Pᵢₙ₂ may be equal to or different from Pᵢₙ₁. Each light source is followed by a differential optical encoder 12, which operates in the manner described in connection with the differential optical encoder of FIG. 1. The first differential optical encoder receives voltage Vₓ₁, which is representative of numeric value x₁. This differential optical encoder encodes the received input optical signal using voltage Vₓ₁ to generate a pair of encoded optical signals having powers Pₜ₁ and P_{b1}. These optical signals are provided as inputs to two differential optical multipliers 14. The top differential optical multiplier receives voltage V_{M11}, which represents numeric value M₁₁. The bottom differential optical multiplier receives voltage V_{M21}, which represents numeric value M₂₁. Both differential optical multipliers operate in the manner described in connection with the differential optical multiplier of FIG. 1. The top differential optical multiplier outputs optical signals P_{b11}′ and Pₜ₁₁′, and the bottom differential optical multiplier outputs optical signals P_{b21}′ and Pₜ₂₁′. The difference between P_{b11}′ and Pₜ₁₁′ is proportional to both M₁₁ and the difference between P_{b1} and Pₜ₁, and accordingly, is proportional to the product M₁₁x₁. Similarly, the difference between P_{b21}′ and P^{t21}′ is proportional to both M₂₁ and the difference between P_{b1} and Pₜ₁, and accordingly, is proportional to the product M₂₁x₁. The four output optical signals are detected using respective photodetectors 60.

The second differential optical encoder receives voltage Vₓ₂, which is representative of numeric value x₂. This differential optical encoder encodes the received input optical signal using voltage Vₓ₂ to generate a pair of encoded optical signals having powers Pₜ₂ and P_{b2}. These optical signals are provided as inputs to two differential optical multipliers 14. The top differential optical multiplier receives voltage V_{M12}, which represents numeric value M₁₂. The bottom differential optical multiplier receives voltage V_{M22}, which represents numeric value M₂₂. Both differential optical multipliers operate in the manner described in connection with the differential optical multiplier of FIG. 1. The top differential optical multiplier outputs optical signals P_{b12}′ and Pₜ₁₂′, and the bottom differential optical multiplier outputs optical signals P_{b22}′ and Pₜ₂₂′. The difference between P_{b12}′ and Pₜ₁₂′ is proportional to both M₁₂ and the difference between P_{b2} and Pₜ₂, and accordingly, is proportional to the product M₁₂x₂. Similarly, the difference between P_{b22}′ and Pₜ₂₂′ is proportional to both M₂₂ and the difference between P_{b2} and Pₜ₂, and accordingly, is proportional to the product M₁₂x₂. The four output optical signals are detected using respective photodetectors 60.

As shown in FIG. 3, the outputs of the photodetectors are combined (see, e.g., node 62), thereby allowing the photocurrents to be added to one another. Receiver circuitry 64 receives the photocurrents produced by detectors 60. Receiver circuitry 64 includes a differential trans-impedance amplifier (or other circuits for subtracting the first input current from the second input current) and an analog-to-digital converter. The top receiver circuitry 64 outputs numeric value y₁=M₁₁x₁+M₁₂x₂. The bottom receiver circuitry 64 outputs numeric value y₂=M₂₁ x₁+M₂₂ x₂. Additional aspects of dual-rail photonic processors are described by U.S. Patent Application Publication No. 2021/0157878, titled “Linear Photonic Processors and Related Methods,” filed on Nov. 23, 2020 and incorporated by reference herein in its entirety.

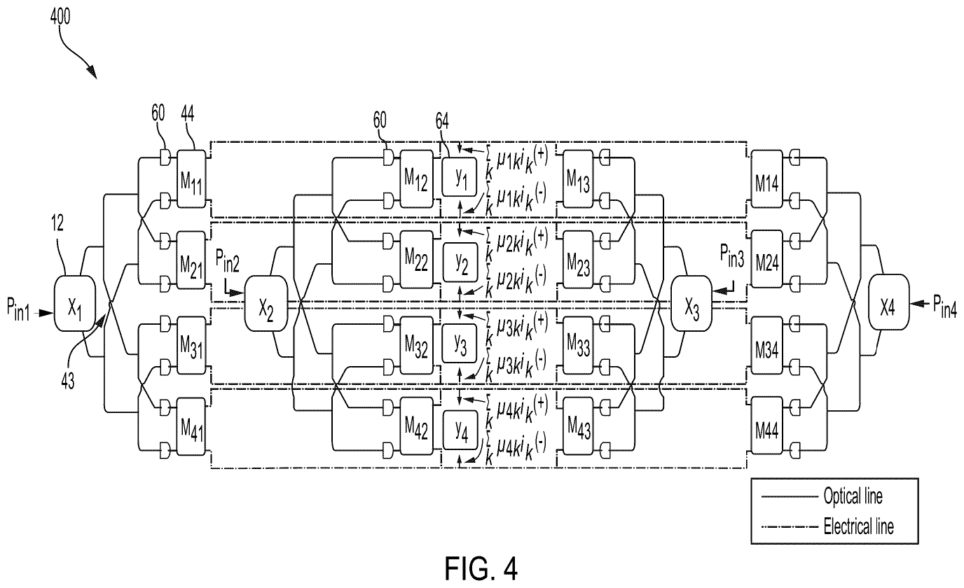

An example of a 4×4 dual-rail photonic processor 400 is illustrated in FIG. 4. Unlike the examples of FIGS. 1-3, the dual-rail photonic processor 400 is configured to perform multiplication operations in the analog RF domain rather than the optical domain. The processor 400 includes four light sources 10 (not shown), four differential encoders 12 (which encode numeric values x₁, x₂, x₃, and x₄ into respective pairs of dual-rail optical signals), sixteen differential analog RF modulators₄₄ (which multiply the respective inputs by, M₁₁, M₂₁, M₃₁, M₄₁, M₁₂, M₂₂, M₃₂, M₄₂, M₁₃, M₂₃, M₃₃, M₄₃, M₁₄, M₂₄, M₃₄ and M₄₄), thirty-two detectors 60 (which convert optical signals into photocurrents), and four receivers 64.

In some embodiments, the detectors 60 convert the optical signals from the differential encoders 12 into photocurrents. The differential analog RF modulators 44 includes analog RF circuitry configured to modulate the two photocurrents (iₖ⁽⁺⁾∝Iₖ⁽⁺⁾∝|Eₖ⁽⁺⁾|² and (iₖ⁽⁻⁾∝Iₖ⁽⁻⁾∝|Eₖ⁽⁻⁾|²) received from the detectors 60. In some embodiments, the differential analog RF modulators 44 include controllable current dividers. For example, the differential analog RF modulators 44 may comprise one or more current branches (e.g., two current branches), each with a controllable conductance. During operation, each input photocurrent may be split between the current branches of the differential analog RF modulators 44, and by controlling the ratio of conductances of the current branches, a proportion of the input photocurrent flowing in each of the output current branches may be controlled. In some embodiments, the differential analog RF modulators 44 output electronic current signals μⱼₖiₖ⁽⁺⁾ and μⱼₖiₖ⁽⁻⁾, whose difference is proportional to the desired multiplication between the matrix element Mⱼₖ and the input vector element xₖ:

Mⱼₖxₖ∝μⱼₖiₖ⁽⁺⁾−μⱼₖiₖ⁽⁻⁾=μᵢⱼ(iₖ⁽⁺⁾−iₖ⁽⁻⁾).

Taking the difference between the current signals in the analog domain and then connecting all the k current signals μⱼₖiₖ⁽⁺⁾−μⱼₖiₖ⁽⁻⁾ together using electronic wires allows the performance of the summation between the different k values of Mⱼₖxₖ. As such, the differential analog RF multipliers 44 and associated circuitry 64 shown in FIG. 4 can compute the output vector y, which is the matrix-vector multiplication between a matrix M and a vector x. In some embodiments, the circuitry 64 includes circuitry configured to receive two input currents (e.g., from differential analog RF modulators 44) and output an electrical signal proportional to the difference between the two input currents.

III. Photonic Processors with Optical Domain Multiplexing and Demultiplexing

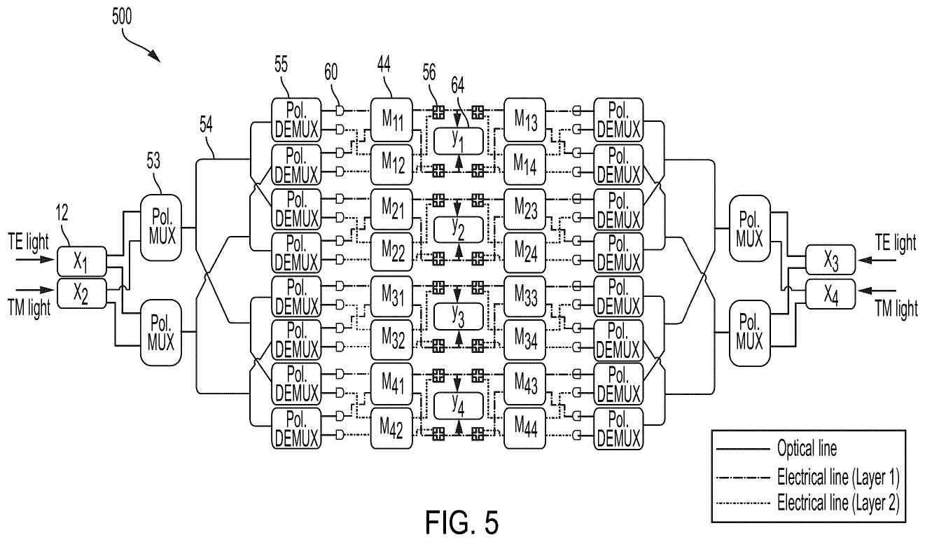

FIG. 5 is a block diagram of a photonic processor 500 arranged according to a 4×4 configuration and including polarization multiplexing, in accordance with some embodiments of the technology described herein. Photonic processor 500 includes four light sources 10 (not shown), the received optical signals of which can be generated from a single light source having a specific frequency. In some embodiments, the different polarizations of the input optical signals can be generated from the single light source and a polarization rotator. The light sources 10 may be configured to produce light of two different polarizations (e.g., TE and TM light) and two different wavelengths. The differential encoders 12 encode numeric values x₁, x₂, x₃, and x₄ into respective pairs of dual-rail optical signals having different polarizations and wavelengths. The encoded optical signals from the top rail of each differential encoder 12 are multiplexed into a single waveguide by a polarization multiplexer 53, and the encoded optical signals on the bottom rail of each differential encoder 12 are multiplexed by another polarization multiplexer 53 into another waveguide. It should be appreciated that, while the example of FIG. 5 shows two optical signals of differing polarizations and wavelengths being multiplexed together, that in some embodiments two or more optical signals of differing polarizations and/or wavelengths may be multiplexed together by polarization multiplexer 53, as aspects of the technology described herein are not limited in this respect.

In some embodiments, outputs of the polarization multiplexers 53 are coupled to a binary splitter tree 54. Each waveguide in the binary splitter tree 54 carries two different multiplexed optical signals that can be differentiated by their wavelength or polarization. The binary splitter tree 54 includes multiple 3 dB optical splitters and multiple optical waveguide crossings so that the multiplexed optical signals from the polarization multiplexers 53 may be transmitted to multiple polarization demultiplexers 55. The polarization demultiplexers 55 are configured to demultiplex a received multiplexed optical signal into two separate waveguides (e.g., into two spatial modes). Each demultiplexed optical signal thereafter is detected by a corresponding photodetector 60 and converted into a first current (e.g., a photocurrent). The first currents are modulated by a respective differential analog RF modulator 44. The differential analog RF modulators 44 are configured to generate second currents representative of a product of a vector and a matrix element. The second currents are thereafter summed by circuitry 64, as previously described in connection with the example of FIG. 4, and output.

In some embodiments, polarization multiplexer 53 and/or polarization demultiplexer 55 include polarization rotators, polarization splitters, and/or polarization combiners. Alternatively, in some embodiments, photonic inverse design methods can be used to design non-resonant passive multiplexer and demultiplexer devices for using both wavelength and polarization as photonic degrees of freedom.

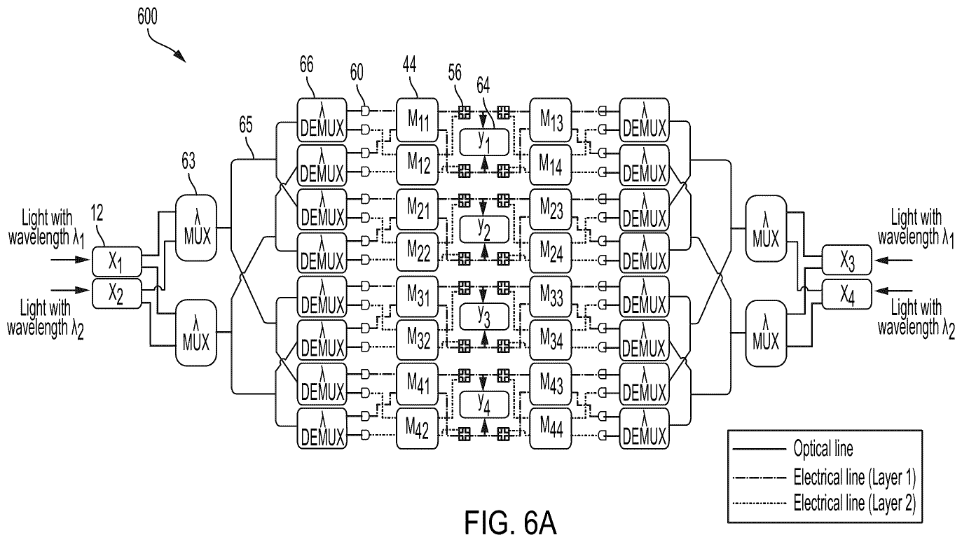

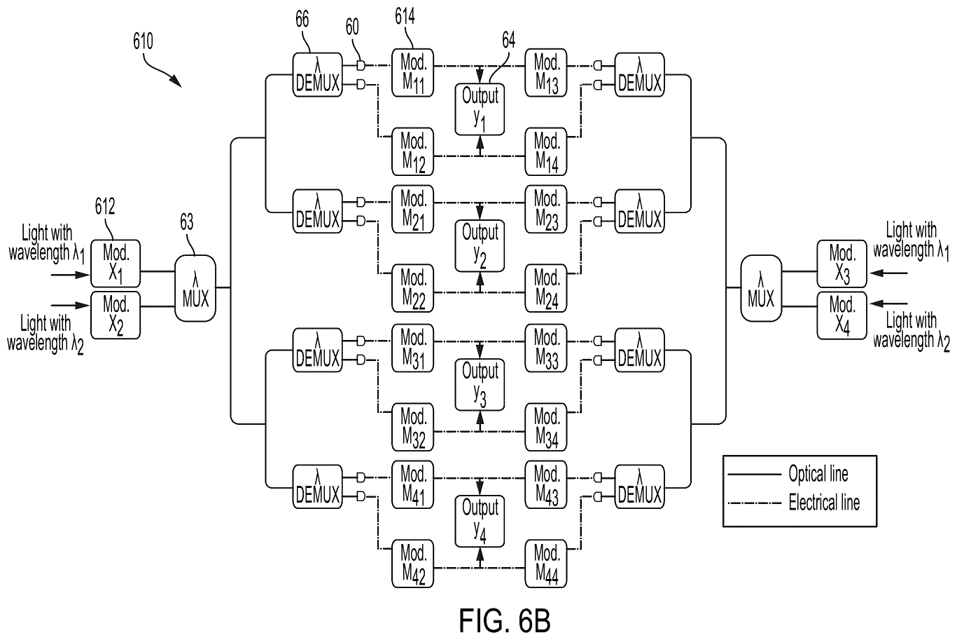

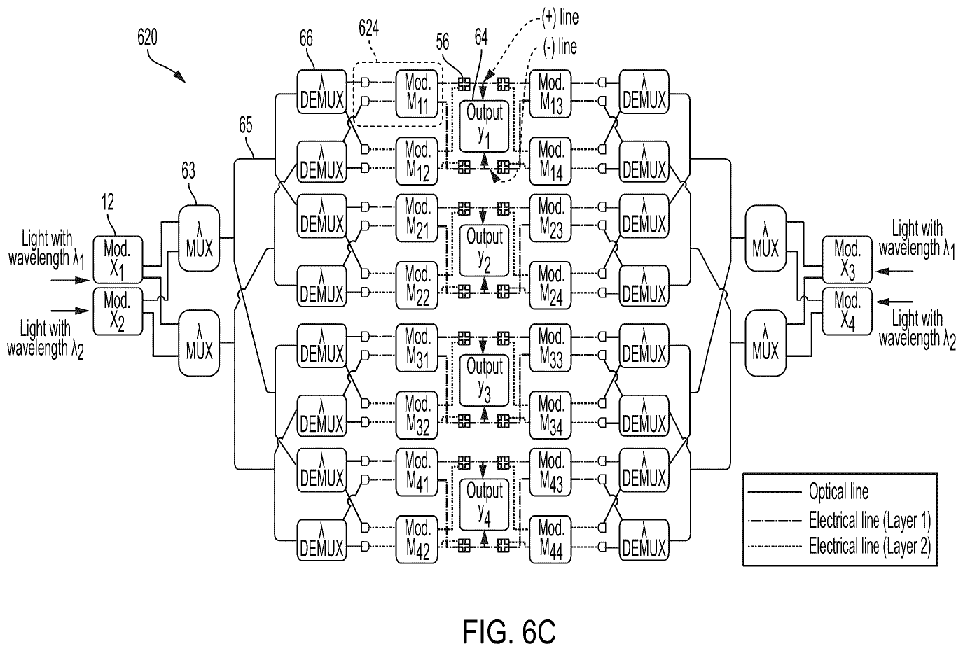

FIG. 6A is a block diagram of a photonic processor 600 arranged according to a 4×4 configuration and including wavelength multiplexing, in accordance with some embodiments of the technology described herein. Photonic processor 600 includes four light sources 10 (not shown) configured to produce light of two different wavelengths, λ₁ and λ₂. The received light from light sources 10 may be generated by two different light sources, each having a different wavelength, in some embodiments. Photonic processor 600 includes differential encoders 12 configured to encode numeric values x₁, x₂, x₃, and x₄ into the received light from light sources 10 and outputting respective pairs of dual-rail optical signals having different polarizations and wavelengths. The encoded optical signals from the top rail of each differential encoder 12 are multiplexed into a single waveguide by a wavelength multiplexer 63, and the encoded optical signals on the bottom rail of each differential encoder 12 are multiplexed by another wavelength multiplexer 63 into another waveguide.

In some embodiments, outputs of the wavelength multiplexers 63 are coupled to a binary splitter tree 65. Each waveguide in the binary splitter tree 65 carries two different multiplexed optical signals that can be differentiated by their wavelength or polarization. The binary splitter tree 65 includes multiple 3 dB optical splitters and multiple optical waveguide crossings so that the multiplexed optical signals from the wavelength multiplexers 63 may be transmitted to multiple wavelength demultiplexers 66. The wavelength demultiplexers 66 are configured to demultiplex a received multiplexed optical signal into two separate waveguides (e.g., into two optical signals with two different wavelengths). Each demultiplexed optical signal thereafter is detected by a corresponding photodetector 60 and converted into a first current (e.g., a photocurrent). The first currents are modulated by a respective differential analog RF modulator 44. The differential analog RF modulators 44 are configured to generate second currents representative of a product of a vector and a matrix element. The second currents are thereafter summed by circuitry 64, as previously described in connection with the example of FIG. 4, and output.

In some embodiments, more than two different wavelengths may be multiplexed together into a single waveguide. Alternatively or additionally, both the wavelength DOF and the polarization DOF may be made use of to increase throughput of the photonic processor 600. Each of optical signal can be regarded as a signal with an electromagnetic mode labeled by a tuple (λ, \vec{k}), where λ is the wavelength and \vec{k} is the polarization. Each optical signal with a unique value of λ and a unique value of \vec{k} is orthogonal to other optical modes. Thus, this optical signal can be multiplexed with other signals having different values of (λ, \vec{k}) and can be demultiplexed from the other signals.

In some embodiments, wavelength multiplexer 63 and/or wavelength demultiplexer 66 comprise ring resonators. The ring resonators may each be tuned to be resonant to a specific wavelength such that the ring performs multiplexing or demultiplexing for that wavelength. In some embodiments, wavelength multiplexer 63 and/or wavelength demultiplexer 66 may be associated with temperature stabilization circuitry (not shown). The temperature stabilization circuitry may be configured to maintain a stable temperature of the ring resonators within wavelength multiplexer 63 and/or wavelength demultiplexer 66, thereby enabling the wavelength multiplexer 63 and/or wavelength demultiplexer 66 to operate reliably as slight changes in temperatures can shift the resonant frequency of ring resonators.

A photonic architecture as described in connection with the examples of FIGS. 5 and 6A significantly reduces the distance traveled by the output first and second currents through electrical wires. The bandwidth of the photonic processor 400 of FIG. 4 is limited by the bandwidth determined by the resistance and the capacitance of the electrical wires. The compact arrangement of photonic processors 500 and 600 reduces the wire resistance and capacitance by reducing the electrical wire length compared to that of the photonic processor 400 such that the bandwidth of the system is improved. Additionally, the output signals generated by photonic processors 500 and 600 have a higher signal-to-noise ratio (SNR) because the reduced wire resistance decreases the signal loss and noise introduced by the wires. Such an advantage is evident in typical CMOS-based silicon photonics fabrication processes where there is only one layer where silicon can be drawn, such that each photonic device must have its own unique coordinates in the 2-D plane. For future photonic fabrication processes where photonic devices can be stacked on top of each other, the advantages of the multiplexing/demultiplexing scheme can be achieved by having two or more modulators or detectors placed on top of one another.

It should be appreciated that in some embodiments of photonic processors 500 and/or 600, the top (+) rail signals and the bottom (−) rail signals need not be multiplexed together. Alternatively, in some embodiments, the top (+) signal from one differential optical encoder 12 may be multiplexed with the bottom (−) signal from another differential optical encoder 12. The demultiplexing operation only requires the distinction between the mode numbers of the optical signals that have been multiplexed together. In this case, that mode number is labeled by the tuple (λ, \vec{k}).

In some embodiments, multiplexing and demultiplexing can be used in place of the binary splitter trees 54, 65, which may have multiple photonic crossings that can introduce loss or crosstalk. In such embodiments, one of the two signal outputs from each differential optical encoder 12 can have its polarization rotated such that one polarization carries the (+) value of the signal and the other polarization carries the (−) value of the signal. In this manner, the binary splitter trees 54, 65 may be simplified or replaced in some embodiments.

FIG. 6B is a block diagram of a single-ended photonic processor 610 including wavelength multiplexing, in accordance with some embodiments of the technology described herein. Photonic processor 610 is a single-ended variation of photonic processor 600 described in connection with FIG. 6A. Photonic processor 610 includes four light sources 10 (not shown) configured to produce light of two different wavelengths, λ₁ and λ₂. The received light from light sources 10 may be generated by two different light sources, each having a different wavelength, in some embodiments. Photonic processor 610 includes encoders 612 configured to encode numeric values x₁, x₂, x₃, and x₄ into the received light from light sources 10 and to each output a single encoded optical signal. The encoded optical signals from each encoder 612 is multiplexed into a single waveguide by a wavelength multiplexer 63.

In some embodiments, outputs of the wavelength multiplexers 63 are coupled to multiple wavelength demultiplexers 66. The wavelength demultiplexers 66 are configured to demultiplex a received multiplexed optical signal into two separate waveguides (e.g., into two optical signals with two different wavelengths). Each demultiplexed optical signal thereafter is detected by a corresponding photodetector 60 and converted into a first current (e.g., a photocurrent). The first currents are modulated by a respective analog RF modulator 614. The analog RF modulators 614 are configured to generate second currents representative of a product of a vector and a matrix element. The second currents are thereafter summed by circuitry 64.

It should be appreciated that the photonic processors 500, 620, and 700 may similarly be adapted to a single-ended architecture as photonic processor 600 was adapted in the example of photonic processor 610, as aspects of the technology described herein are not limited in this respect.

FIG. 6C is a block diagram of a photonic processor 620 arranged according to a 4×4 configuration and including modulatable detectors and wavelength multiplexing, in accordance with some embodiments of the technology described herein. Photonic processor 620 includes four light sources 10 (not shown) configured to produce light of two different wavelengths, λ₁ and λ₂. The received light from light sources 10 may be generated by two different light sources, each having a different wavelength, in some embodiments. Photonic processor 620 includes differential encoders 12 configured to encode numeric values x₁, x₂, x₃, and x₄ into the received light from light sources 10 and outputting respective pairs of dual-rail optical signals having different polarizations and wavelengths. The encoded optical signals from the top rail of each differential encoder 12 are multiplexed into a single waveguide by a wavelength multiplexer 63, and the encoded optical signals on the bottom rail of each differential encoder 12 are multiplexed by another wavelength multiplexer 63 into another waveguide.

In some embodiments, outputs of the wavelength multiplexers 63 are coupled to a binary splitter tree 65, and thereafter the multiplexed optical signals from the wavelength multiplexers 63 may be transmitted to multiple wavelength demultiplexers 65. The wavelength demultiplexers 65 are configured to demultiplex a received multiplexed optical signal into two separate waveguides (e.g., into two optical signals with two different wavelengths).

In some embodiments, pairs of demultiplexed optical signals (e.g., pairs of top rail or pairs of bottom rail optical signals) may thereafter be detected and modulated by a modulatable detector 624. The modulatable detectors 624 are configured to generate and output electrical signals (e.g., currents) representative of a product (y) of a vector (x) and a matrix element (M) based on the received optical signals from the wavelength demultiplexers 66. The output currents are thereafter combined by vias 56 and summed by circuitry 64, as previously described in connection with the example of FIG. 4, and output.

In some embodiments, the modulatable detectors 624 are optical detectors having at least one characteristic that can be controlled by a user using one or more electric control signals. The modulatable detectors 624 are designed so that the application of such a control signal (e.g., a voltage, current, or charge) alters a characteristic of the detector (e.g., the responsivity, gain, impedance, etc.). As a result, the photocurrent output by the modulatable detectors 624 depends not only on the received optical signals but also on the control signal applied to the detector. Additional aspects of modulatable detectors are described by U.S. Patent Application Publication No. 2021/0157878, titled “Linear Photonic Processors and Related Methods,” filed on Nov. 23, 2020 and incorporated by reference herein in its entirety.

It should be appreciated that the photonic processors 500, 610, and 700 may similarly be adapted to include modulatable detectors 624 as photonic processor 600 was adapted in the example of photonic processor 620, as aspects of the technology described herein are not limited in this respect.

IV. Photonic Processors with Analog RF Domain Demultiplexing

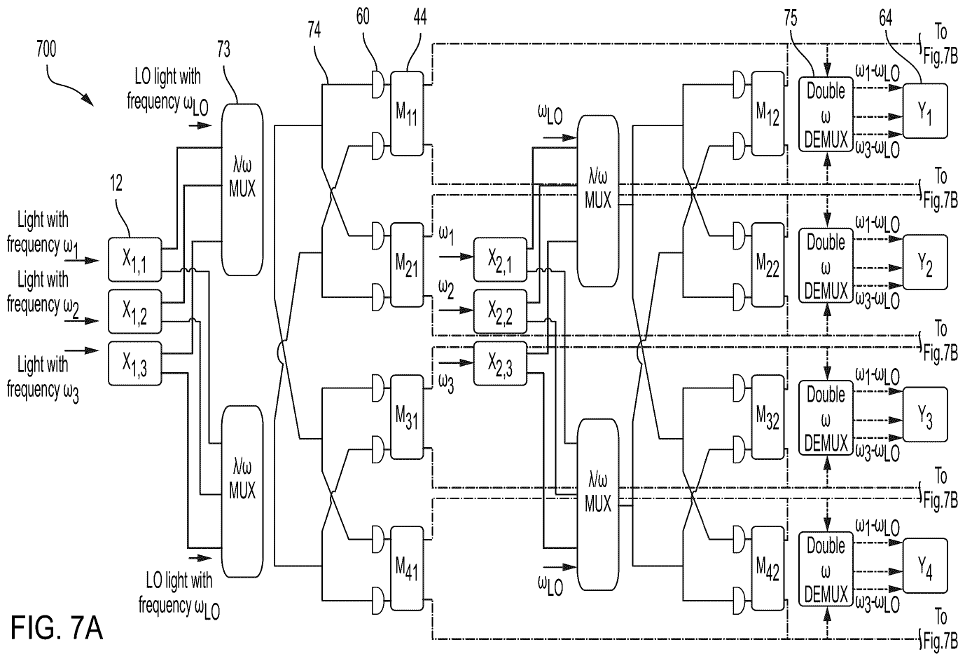

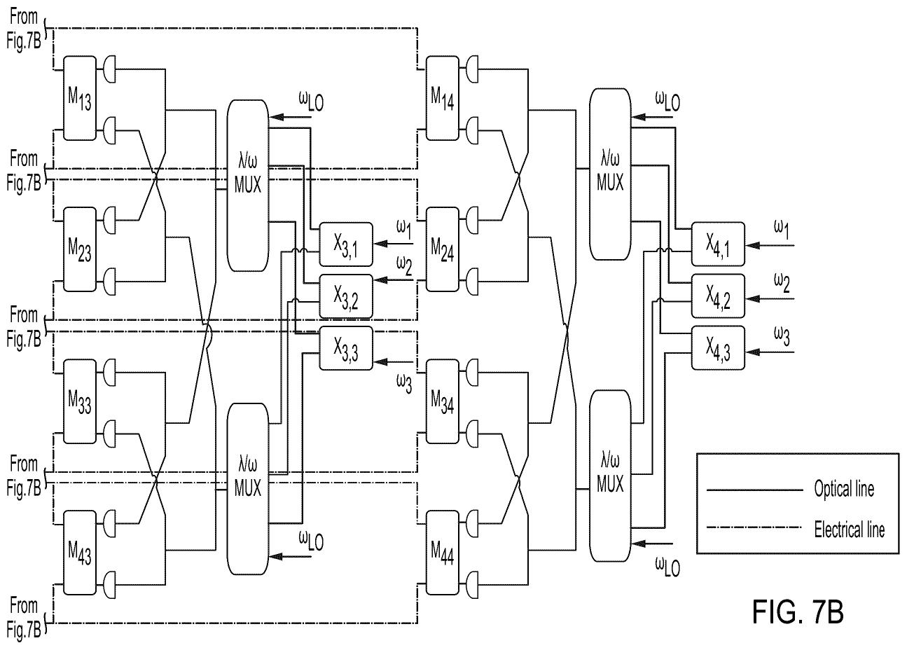

FIGS. 7A and 7B are a block diagram of a photonic processor 700 configured to perform matrix-matrix multiplication of a 4×3 matrix X and a 4×4 matrix M, in accordance with some embodiments of the technology described herein. The photonic processor 700 includes frequency multiplexing in the optical domain and frequency demultiplexing in the analog RF domain. The photonic processor 700 includes twelve light sources 10 (not shown) configured to input light of two or more different frequencies to the photonic processor 700. In some embodiments, the input light may be generated using three light sources, each having a different frequency. Input light of three different frequencies ω₁, ω₂, and ω₃ are shown in the example of FIGS. 7A and 7B. The input light is received by respective differential optical encoders 12, each configured to encode a matrix element x_{k,i} into an output encoded optical signal. Contrary to the operation of photonic processor 400 as described in connection with FIG. 4, each differential optical encoder 12 in photonic processor 700 is configured to encode the vector values x_{k,i} into a difference between the absolute value of the amplitude of the light in the top rail (|E_{k,i}⁽⁺⁾|∝\sqrt{I_{k,i}⁽⁺⁾}) and the absolute value of the amplitude of the light in the bottom rail (|E_{k,i}⁽⁻⁾|∝\sqrt{I_{k,i}⁽⁻⁾}). Accordingly:

x_{k,i}∝(\sqrt{I_{k,i}⁽⁺⁾}−\sqrt{I_{k,i}⁽⁻⁾})∝|E_{k,i}⁽⁺⁾|−|E_{k,i}⁽⁻⁾|.

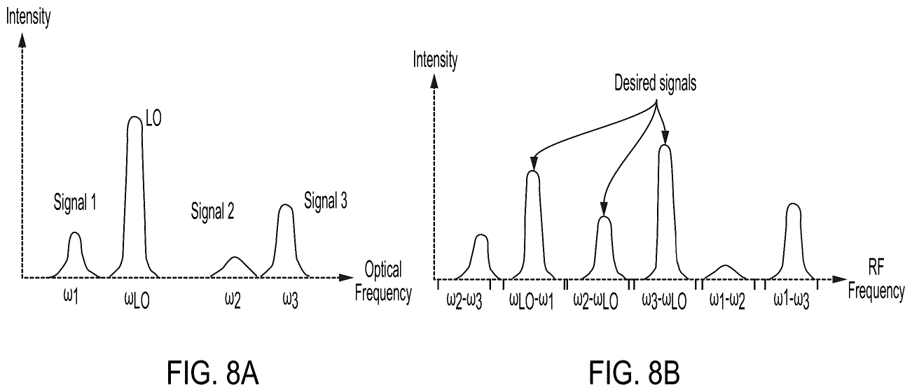

The encoded optical signals output by the differential optical encoders 12 are multiplexed into a single waveguide by frequency multiplexers 73. FIG. 8A shows an example of a multi-frequency, multiplexed optical signal output by frequency multiplexers 73 including individual optical frequencies ω₁, ω₂, ω₃, and ω_{LO}. The optical frequencies include the optical frequency of a local oscillator (LO), ω_{LO}. In some embodiments, different frequencies of light may be used to encode the top rail (+) signal and the bottom rail (−) signal. One possible choice is to have frequency of light encoding the top (+) and bottom (−) signals to be encoded with frequencies on either side of the LO frequency (e.g., |ωᵢ⁽⁺⁾−ω_{LO}|=|ωᵢ⁽⁻⁾−ω_{LO}| but ωᵢ⁽⁺⁾≠ωᵢ⁽⁻⁾).

The additional optical signal from a local oscillator (LO) is multiplexed with the encoded optical signals from the differential optical encoders 12 to enable later demultiplexing in the analog RF domain. The frequency of the optical signal from the LO is different than the frequency of the encoded optical signals from the differential optical encoders 12. Accordingly, the total electric field present in the top (+) waveguide at the output of the k^{th} column of the differential optical encoders 12 is:

$${E}_{k}^{( + )} = {E}_{k , 1}^{( + )} cos ( {ω}_{1} t + {ϕ}_{1}^{( + )} ) + {E}_{k , 2}^{( + )} cos ( {ω}_{2} t + {ϕ}_{2}^{( + )} ) + … + {E}_{k , N}^{( + )} cos ( {ω}_{N} t + {ϕ}_{N}^{( + )} ) + {E}_{k , LO} cos ( {ω}_{LO} t + {ϕ}_{LO} )$$

$${E}_{k}^{( + )} = {\sum }_{i = 1}^{N} {E}_{k , i}^{( + )} cos ( {ω}_{i} t + {ϕ}_{i}^{( + )} ) + {E}_{LO} cos ( {ω}_{LO} t + {ϕ}_{LO} )$$

where it is assumed that N different optical signal frequencies {ω₁, . . . , ω_{N}} are being multiplexed. Similarly, the total electric field present in the bottom (−) waveguide is given by:

$${E}_{k}^{( - )} = {\sum }_{i = 1}^{N} {E}_{k , i}^{( - )} cos ( {ω}_{i} t + {ϕ}_{i}^{( - )} ) + {E}_{LO} cos ( {ω}_{LO} t + {ϕ}_{LO} ) .$$

It is assumed that the LO in the top waveguide and the bottom waveguide are identical with regards to amplitude, frequency, and/or phase. While this assumption simplifies the above expressions, in practice this assumption is not necessary because (1) the differential analog RF modulators 44 can normalize against the amplitude of the LO received in each arm, (2) the difference in frequency between the LO and the actual signal Eᵢ is important for demultiplexing the signals, and (3) the phase difference between the LO and signal will not be used.

At the detectors 60, there will be a total of N+1 optical signals of different frequencies, where the additional signal is from the LO. The photocurrent generated by the top rail (+) detectors 60 will therefore be:

$${i}_{k}^{( + )} ∝ {\vert {E}_{k}^{( + )} \vert}^{2}$$

$${\vert {E}_{k}^{( + )} \vert}^{2} = \frac{1}{2} {\sum }_{i = 1}^{N} {\vert {E}_{k , i}^{( + )} \vert}^{2} + \frac{1}{2} {\vert {E}_{LO} \vert}^{2} + {\sum }_{i , j ( i \neq j )} \vert {E}_{k , i}^{( + )} \vert \vert {E}_{k , j}^{( + )} \vert cos ( ( {ω}_{i} - {ω}_{j} ) t + {ϕ}_{i}^{( + )} - {ϕ}_{j}^{( + )} ) + {\sum }_{i = 1}^{N} \vert {E}_{k , i}^{( + )} \vert \vert {E}_{LO} \vert cos ( ( {ω}_{i} - {ω}_{LO} ) t + {ϕ}_{i}^{( + )} - {ϕ}_{LO} ) .$$

The above equation is obtained after integrating and averaging out the fast optical frequency terms. In the equation above, there are four terms that will contribute to the current. The first term is the individual power of the optical signals and the second term is the individual power of the LO. The third term is the cross term between the different optical signals, and each particular cross term has a beat frequency of (ωᵢ−ωⱼ). The fourth term is the cross term between each optical signal and the LO, and each cross term has a beat frequency of (ωᵢ−ω_{LO}). For the photocurrent generated by the bottom (−) detector, the exact calculation can be obtained by replacing all (+) by (−) in the above equation. FIG. 8B shows the encoded optical frequencies in the first currents output by detectors 60 of photonic processor 700. The optical frequencies are encoded in the field amplitude of the output analog RF signal by detectors 60 as described above.

A top rail (+) and bottom rail (−) detector 60 each pass a respective current signal to a differential analog RF modulator 44. The differential analog RF modulators 44 are configured to modulate the two photocurrents to generate second current signals, μₘₖiₖ⁽⁺⁾ and μₘₖiₖ⁽⁻⁾. The output second current signal at the top (+) electrical output is given by:

$${μ}_{mk} {i}_{k}^{( + )} ∝ \frac{1}{2} {\sum }_{i = 1}^{N} {μ}_{mk} {\vert {E}_{k , i}^{( + )} \vert}^{2} + \frac{1}{2} {μ}_{mk} {\vert {E}_{LO} \vert}^{2} + {\sum }_{i , j ( i \neq j )} {μ}_{mk} \vert {E}_{k , i}^{( + )} \vert \vert {E}_{k , j}^{( + )} \vert cos ( ( {ω}_{i} - {ω}_{j} ) t + {ϕ}_{i}^{( + )} - {ϕ}_{j}^{( + )} ) + {\sum }_{i = 1}^{N} {μ}_{mk} \vert {E}_{k , i}^{( + )} \vert \vert {E}_{LO} \vert cos ( ( {ω}_{i} - {ω}_{LO} ) t + {ϕ}_{i}^{( + )} - {ϕ}_{LO} ) .$$

The expression for the output second current signal at the bottom (−) electrical output, μₘₖiₖ⁽⁻⁾, is similar and can be determined by substituting (−) superscripts for (+) superscripts in the above expression.

The output second current signals are then demultiplexed in the analog RF domain by the analog frequency demultiplexers 75 to obtain the desired multiplication between the matrix element Mₘₖ and the input vector element x_{k,i}:

Mₘₖx_{k,i}∝μₘₖ(|E_{k,i}⁽⁺⁾|−|E_{k,i}⁽⁻⁾|).

To demultiplex the second current signals, the signals μₘₖiₖ⁽⁺⁾ can be mixed with a pure tone at frequency (ωᵢ−ω_{LO}) to obtain a DC electronic signal whose amplitude is proportional to μₘₖ|E_{k,i}⁽⁺⁾∥E_{LO}|.

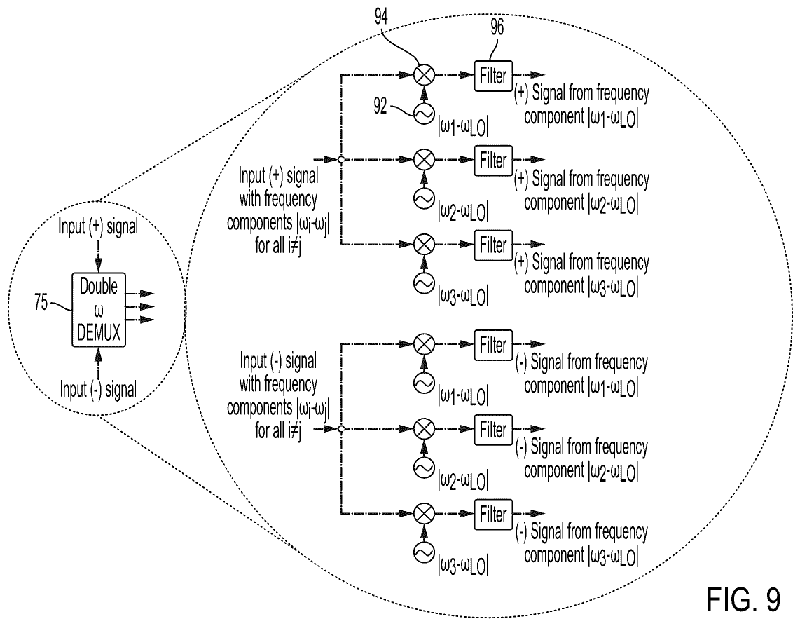

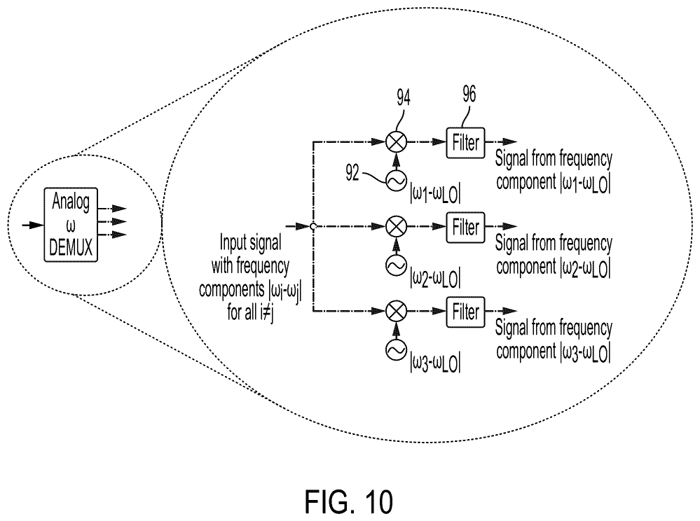

FIG. 9 shows an example of circuitry for performing the demultiplexing operations of analog frequency demultiplexers 75 using intermediate frequency (IF) mixing for a dual-rail signal. For a multi-rail signal, as with the dual-rail signal of photonic processor 700, the demultiplexing operation can be done in parallel by including the same circuitry for each rail. FIG. 10 shows an example circuitry for performing the demultiplexing operations in the analog RF domain using IF mixing and for a single-rail signal. For the single-ended example of FIG. 10, there is only a single connection between the optical encoders and the detectors and there is not a top (+) waveguide and bottom (−) waveguide).

The circuitry for both the examples of FIGS. 9 and 10 includes current sources 92 for introducing the pure tone frequencies (ωᵢ−ω_{LO}) with the received current signals from the differential analog RF modulators 44. The two signals are mixed by frequency mixer 94, and the output of frequency mixer 94 is filtered by filter 96. In some embodiments, the filter 96 may include any suitable filter including bandpass and/or digital filters.

The same demultiplexing operations are performed in the bottom (−) electronic signal output to obtain a DC electronic signal whose amplitude is proportional to μₘₖ|E_{k,i}⁽⁻⁾∥E_{LO}|. Because the relevant signal is encoded in the amplitude of the beat whose frequency is (ωᵢ−ω_{LO}), this beat frequency is unique to that signal alone. In other words, for this scheme to work, (ωᵢ−ω_{LO})≠(wⱼ−ω_{LO}) for any choice of i and j and (ωᵢ−ω_{LO})≠(ωⱼ−ωₖ) for any choice of i, j, and k. Interestingly, and as should be appreciated from the above description, the output signal amplitude is proportional to the product of the amplitude of the encoded optical signal and the amplitude of the LO signal. Increasing the amplitude of the LO will accordingly boost the output signal-to-noise ratio (SNR) of all the signals.

To perform the summation of the different k values of Mⱼₖx_{k,i}, the difference is taken between the second current signals in the analog RF domain. Thereafter, the k current signals |E_{LO}|μⱼₖ(|E_{k,i}⁽⁺⁾|−|E_{k,i}⁽⁻⁾|) are connected together using electrical wires to perform the desired summation.

The inventors have recognized that the design of photonic processor 700 as described in connection with the example of FIGS. 7A and 7B enables a highly parallelizable linear photonic processor. In particular, photonic processor 700 allows for the simultaneous multiplication of multiple input vectors. While the design of photonic processor 700 does require more differential optical encoders 12 and additional multiplexing and demultiplexing circuitries, which scale with the size of the input vectors, the design does not require any additional differential analog RF modulators 44, the number of which scales with the size of the input matrix M.

One additional design benefit of multiplexing the multi-frequency signals to propagate in a single waveguide is that all the optical signals at the different wavelengths are automatically phase-stable as long as the waveguides, the crossings, and the splitter components in the binary splitter tree 74 are not dispersive within the wavelength and/or frequency bandwidth of interest. All the frequency components pass through the same optical path from each photonic modulator to each photodetector. Therefore, any variation due thermal instability or other environmental effects that affect the phase stability of the binary splitter tree 74 in a dynamic manner will apply the same phase shift to each frequency signal equally. Phase stability between the different wavelengths is important because the signal is encoded in the interference between the LO and each optical signal.

It should be appreciated that demultiplexing may be performed between detectors 60 and differential analog RF modulators 44, in some embodiments. In such embodiments, the benefit of applying the same matrix element modulation to all the signals simultaneously is lost, but a more compact circuitry arrangement may be achieved that can increase the SNR or the bandwidth of the system as described in connection with the examples of FIGS. 5 and 6A.

Alternatively, it should be appreciated that demultiplexing may be performed to each individual output of the differential analog RF modulators 44, in some embodiments. In such embodiments, additional demultiplexing circuitry enables the demultiplexing of the output second current signals prior to the summation of the contributions from the k columns of detectors 60.

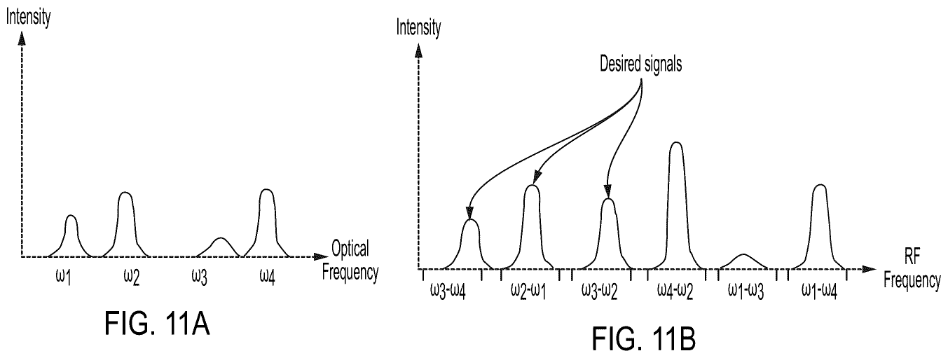

It should further be appreciated that in some embodiments it is not necessary to have a dedicated LO. In such embodiments, the input optical signals may be encoded to be in the cross amplitude multiplication between two electric fields (e.g., xᵢ∝|Eᵢ∥Eᵢ₊₁| for i=1, . . . , N). This alternative encoding is shown in FIGS. 11A and 11B. There are four different input optical frequencies, as shown in the example of FIG. 11A, and the signals are encoded in the multiplication of field amplitudes between neighboring optical frequencies (e.g., (ω₁, ω₂), (ω₂, ω₃), and (ω₃, ω₄)) as shown in FIG. 11B. The signals are encoded in the beat frequency of neighboring signals. Such a scheme has an advantage of keeping the relevant beat frequencies towards the lower end of the range of frequencies, which is useful when using analog RF components whose bandwidths are limited to the hundreds of gigahertz.

It should further be appreciated that the architectures of photonic processors 500 and 600 do not prevent the implementation of the architecture of photonic processor 700. One could reasonably perform all-optical multiplexing/demultiplexing using the polarization DOF and thereafter perform demultiplexing in the analog RF domain using the wavelength DOF, or vice versa. Alternatively, one could design a photonic processor where some wavelengths are demultiplexed in the optical domain as done in photonic processors 500 and 600 and some wavelengths are demultiplexed in the analog RF domain as implemented in photonic processor 700.

It should be appreciated that while photonic processors 500, 600,610, 620, and 700 are shown arranged to accommodate a 4×4 matrix for simplicity, that photonic processors may generally be arranged to accommodate any N×N matrix. For example, in some embodiments, the photonic processor may be arranged to accommodate a 64×64 matrix, a 128×128 matrix, and/or a 256×256 matrix.

It should be appreciated that photonic processors 500, 600, and 700, while shown as dual-rail photonic processors, may also be implemented as single-ended photonic processors as described herein in connection with photonic processor 610.

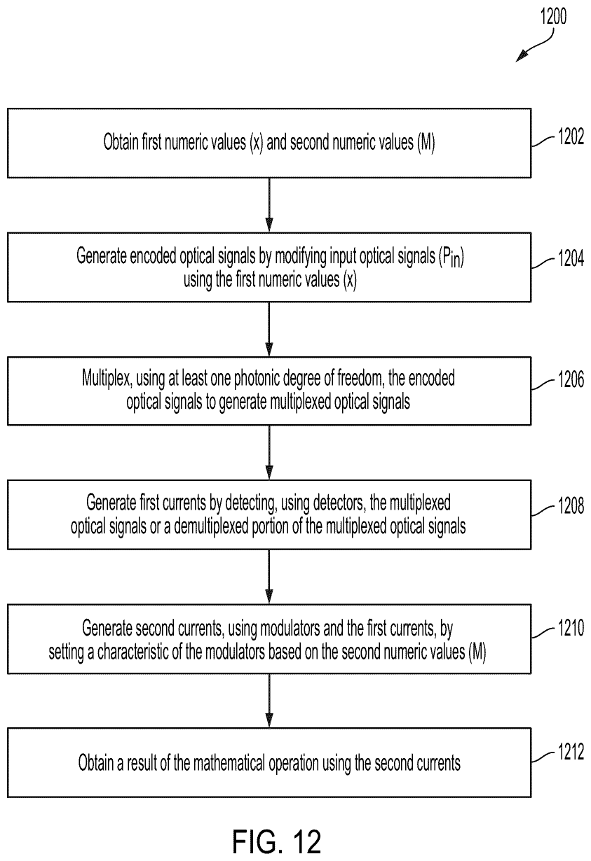

FIG. 12 is a flow chart illustrating a method 1200 for performing multiplication operations using a photonic processor (e.g., photonic processor 500, 600, and/or 700) including multiplexing using one or more photonic DOFs, in accordance with some embodiments of the technology described herein. Method 1200 can be performed using any suitable photonic processor, including the photonic processors 500, 600, 610, 620, and 700 as described in connection with FIGS. 5, 6A, 6B,6C, and 7A and 7B herein, or any suitable variations on the same.

Method 1200 begins at act 1202, in which the photonic processor obtains first numeric values and second numeric values. Referring to the example of the architecture of FIG. 1, at act 1202, the numeric value unit 18 generates first numeric values (e.g., vector values x) and second numeric values (e.g., matrix values M) based on data stored in a memory of controller 17 and/or on data obtained from another computing system. The numeric values need not be obtained simultaneously. These numeric values may represent any type of information, such as text, audio, video, imagery, etc. The numeric values may be real or complex and positive or negative values.

Thereafter, method 1200 proceeds to act 1204, in which encoded optical signals are generated by modifying input optical signals using the first numeric values. Referring to the example of the architecture of FIGS. 7A and 7B, the differential optical encoders 12 generate encoded optical signals by modulating the input optical signals (e.g., the light with frequencies ω₁, ω₂, and ω₃) based on a received first numeric value x. For example, in a dual-rail photonic processor, the differential optical encoders 12 may encode the first numeric value x such that the first numeric value x is proportional to a difference (e.g., a difference in power or amplitude) between a top (+) and bottom (−) output optical signal. In some embodiments (e.g., single-ended embodiments), the first numeric value x may be encoded into a single encoded optical signal (e.g., into a polarization of the optical signal).

After performing act 1204, method 1200 proceeds to act 1206. At act 1206, the encoded optical signals are multiplexed using at least one photonic DOF to generate multiplexed optical signals. For example, the encoded optical signals may be multiplexed based on their polarization (e.g., as described in connection with photonic processor 500), their wavelength (e.g., as described in connection with photonic processor 600), and/or their frequency (e.g., as described in connection with photonic processor 700).

The multiplexed optical signals are then transmitted through single waveguides and/or binary splitter trees (e.g. binary splitter trees 54, 65, 74) to detectors (e.g., detectors 60) at act 1208. At act 1208, the detectors generate first currents by detecting and converting received optical signals into currents (e.g., photocurrents). In some embodiments, the detectors 60 receive and convert the multiplexed optical signals from the multiplexer (e.g., multiplexers 73) of the photonic processor. In some embodiments, the detectors 60 receive and convert a demultiplexed portion of the multiplexed optical signals from a demultiplexer (e.g., demultiplexers 55, 66).

After generating the first currents in act 1208, method 1200 proceeds to act 1210. At act 1210, second current signals are generated by, for example, differential analog RF modulators 44. In some embodiments, the differential analog RF modulators 44 generate a pair of second current signals by modulating the first current signals using the second numeric values M. In some embodiments (e.g., single-ended embodiments), a respective analog RF modulator may modulate a single received first current signal using a second numeric value M.

Method 1200 then proceeds to act 1212, in which a result of the mathematical operation is obtained using the second current signals generated by the differential analog RF modulators 44. In some embodiments, act 1212 includes receiving one or more second current signals (e.g., using a trans-impedance amplifier to obtain an output voltage) and converting the output signal using an analog-to-digital converter to obtain a numeric value representing the result (e.g., the product of a first numeric value x and a second numeric value M).

Having thus described several aspects of at least one embodiment of this technology, it is to be appreciated that various alterations, modifications, and improvements will readily occur to those skilled in the art.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, examples of which are provided herein including with reference to FIG. 5. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1.-20. (canceled)

21. A photonic processor configured to perform multiplication between a first matrix and a second matrix, the photonic processor comprising:
a multiplexer configured to generate a multiplexed optical signal by multiplexing, using at least one photonic degree of freedom, a first optical signal generated by a local oscillator and second optical signals generated by encoding numeric values of elements of the first matrix into optical signals received from one or more light sources; and
a modulator coupled to an output of the multiplexer and configured to generate an output signal by modulating a received signal originating from the multiplexer based on a numeric value of an element of the second matrix, wherein the output signal is representative of products of a numeric value of an encoded element of the first matrix and the numeric value of the element of the second matrix.

22. The photonic processor of claim 21, further comprising a detector coupled between an output of the multiplexer and an input of the modulator wherein the detector is configured to generate a first current based on the multiplexed optical signal.

23. The photonic processor of claim 22, wherein the received signal comprises the first current generated by the detector and the output signal comprises a second current generated by the modulator.

24. The photonic processor of claim 22, wherein:
the detector comprises a plurality of detectors, each detector of the plurality of detectors being coupled to outputs of an optical path including the multiplexer and configured to generate the first current,
the modulator comprises a plurality of modulators, each modulator of the plurality of modulators being coupled to an output of one or more detectors of the plurality of detectors, and
the plurality of modulators are configured to generate second currents by modulating the first current based on numeric values of elements of the second matrix.

25. The photonic processor of claim 24, further comprising a demultiplexer coupled to a combined output of the plurality of modulators, the demultiplexer configured to demultiplex the combined output of the plurality of modulators using demultiplexing signal having a frequency related to a frequency of the local oscillator.

26. The photonic processor of claim 21, wherein the at least one photonic degree of freedom is one of a selection of wavelength or frequency.

27. The photonic processor of claim 23, further comprising one or more differential optical encoders optically coupled to one or more inputs of the multiplexer, the one or more differential optical encoders being configured to generate the second optical signals by encoding numeric values of elements of the first matrix into the optical signals received from one or more light sources.

28. The photonic processor of claim 27, wherein:
the second optical signals comprising top rail second optical signals and bottom rail second optical signals, and
the one or more differential optical encoders are configured to generate the top rail second optical signals and the bottom rail second optical signals by encoding the numeric values of elements of the first matrix into a difference between an absolute value of amplitudes of light in a top rail second optical signal and an absolute value of an amplitude of light in a bottom rail second optical signal.

29. The photonic processor of claim 28, wherein:
the top rail second optical signals have a first frequency,
the bottom rail second optical signals have a second frequency, and
the first frequency and the second frequency are different than a frequency of the first optical signal generated by the local oscillator.

30. The photonic processor of claim 28, wherein:
the multiplexed optical signal comprises a top rail multiplexed optical signal and a bottom rail multiplexed optical signal,
the multiplexer comprises a top rail multiplexer and a bottom rail multiplexer,
the top rail multiplexer is configured to generate the top rail multiplexed optical signal by multiplexing the top rail second optical signals, and
the bottom rail multiplexer is configured to generate the bottom rail multiplexed optical signal by multiplexing the bottom rail second optical signals.

31. The photonic processor of claim 30, wherein:
the detector comprises a top rail detector coupled to an output of the top rail multiplexer and a bottom rail detector coupled to an output of the bottom rail multiplexer,
the first current comprises a top rail first current and a bottom rail first current,
the top rail detector is configured to generate the top rail first current using the top rail multiplexed optical signal, and
the bottom rail detector is configured to generate the bottom rail first current using the bottom rail multiplexed optical signal.

32. The photonic processor of claim 31 wherein:
the modulator is coupled to an output of the top rail detector and to an output of the bottom rail detector, and
the second current comprises a top rail second current and a bottom rail second current.

33. The photonic processor of claim 32, wherein:
the detector comprises a first plurality of detectors and a second plurality of detectors,
the first plurality of detectors are coupled to outputs of an optical path including the top rail multiplexer,
the second plurality of detectors are coupled to outputs of an optical path including the bottom rail multiplexer, and
the first current comprises a top rail first current generated by the first plurality of detectors and a bottom rail first current generated by the second plurality of detectors.

34. The photonic processor of claim 33, wherein:
the modulator comprises a plurality of modulators, each modulator of the plurality of modulators being coupled to an output of one of the first plurality of detectors and an output of one of the second plurality of detectors,
modulators of the plurality of modulators are configured to generate top rail second currents by modulating the top rail first current based on elements of the second matrix, and
the modulators of the plurality of modulators are configured to generate bottom rail second currents by modulating the bottom rail first current based on the elements of the second matrix.

35. The photonic processor of claim 34, further comprising a demultiplexer coupled to a top rail output of the plurality of modulators and to a bottom rail output of the plurality of modulators, wherein:
the top rail output comprises a combined output of the top rail second currents,
the bottom rail output comprises a combined output of the bottom rail second currents, and
the demultiplexer is configured to demultiplex the top rail output and the bottom rail output to generate demultiplexed combined outputs comprising electrical signals.

36. The photonic processor of claim 35, wherein the demultiplexer is configured to demultiplex the top rail output and the bottom rail output using intermediate frequency mixing.

37. The photonic processor of claim 36, wherein the demultiplexer is configured to demultiplex the top rail output and the bottom rail output by mixing each of the top rail output and the bottom rail output with a pure tone at a frequency equal to a difference between a frequency of one of the optical signals received from one or more light sources and a frequency of the first optical signal generated by the local oscillator.

38. The photonic processor of claim 35, further comprising summing circuitry configured to sum the electrical signals output by the demultiplexer to generate a summed signal, the summed signal representative of a portion of a result of the multiplication of the first matrix and the second matrix.

39. A method for performing matrix-matrix multiplication between a first matrix and a second matrix using a photonic processor, the method comprising:
obtaining first numeric values representing at least a portion of the first matrix and second numeric values representing at least a portion of the second matrix;
generating encoded optical signals by modifying input optical signals using the first numeric values;
multiplexing, using at least one photonic degree of freedom and a multiplexer, the encoded optical signals and an optical signal generated by a local oscillator to generate multiplexed optical signals;
generating output signals, using modulators and signals received by the modulators and originating from the multiplexer, by setting a characteristic of the modulators based on the second numeric values, wherein the generated output signals represent a portion of a result of the matrix-matrix multiplication; and
obtaining a result of the matrix-matrix multiplication using the output signals and a demultiplexing signal having a frequency related to a frequency of the optical signal generated by the local oscillator.

40. The method of claim 39, further comprising generating first currents by detecting, using detectors, the multiplexed optical signals.

41. The method of claim 40, wherein the signals received by the modulators and originating from the multiplexer comprise the first currents, and generating the output signals comprises generating second currents using the modulators and the first currents.

42. The method of claim 41, further comprising generating third currents by summing two or more of the second currents, and wherein obtaining the result of the matrix-matrix multiplication comprises demultiplexing the third currents using intermediate frequency mixing.

43. The method of claim 42, wherein demultiplexing the third currents using intermediate frequency mixing comprises mixing the third currents with a pure tone at a frequency equal to a difference between a frequency of the encoded optical signals and a frequency of the optical signal generated by the local oscillator.

44. The method of claim 39, wherein generating the encoded optical signals comprises generating encoded optical signals corresponding to a top rail and encoded optical signals corresponding to a bottom rail,
wherein numeric values of elements of the first matrix are encoded into a difference between an absolute value of amplitudes of light in the top rail and an absolute value of an amplitude of light in the bottom rail.
